(19) United States
(12) Patent Application Publication
(10) Pub. No.: US 2015/0254409 A1
(43) Pub. Date: Sep. 10, 2015

(54) PATIENT DATA EXCHANGE

(71) Applicant: PHONAK AG, Stäfa (CH)

(72) Inventors: Philipp Schneider, Zurich (CH); Stefan Kuenzle, Uster (CH); Tim Roth, Uster (CH)

(21) Appl. No.: 14/435,218

(22) PCT Filed: Oct. 25, 2012
(86) PCT No.: PCT/EP2012/071156

§ 371 Date: Apr. 13, 2015

(51) Int. Cl. G06F 19/00

(52) U.S. Cl. CPC G06F 19/345; G06F 19/321

(57) ABSTRACT

The invention relates to a method for simplified patient data exchange, e.g. between a patient and a hearing device dispenser. The information provided by the patient in visual form is digitally imaged, and the relevant patient information is extracted from thus-generated image data. This data is then applied for various hearing device dispensing and controlling functions.

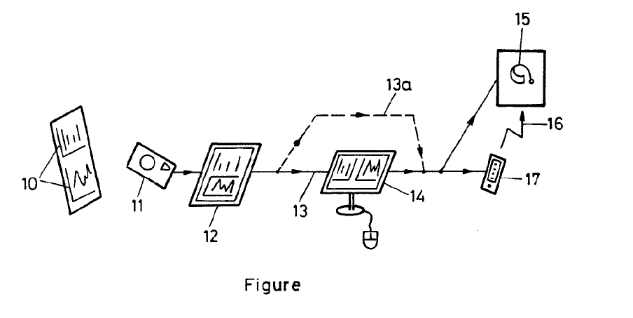

### TECHNICAL FIELD OF THE INVENTION

The present invention relates to a method of simple exchange of patient data, such as audiogram data, in the process of acquiring a hearing device.

### BACKGROUND OF THE INVENTION

By hearing device we understand both hearing aids for improving the hearing perception of a hearing-impaired individual, tinnitus treatment devices, or similar, which may be situated in the ear, behind the ear, or may be implanted, and also active hearing protection for gunfire or other loud noises, etc.

In the case of hearing aids, tinnitus treatment devices and so on, these devices need to be acoustically fitted to the patient. This entails programming various parameters of the hearing device, such as frequency-dependent amplification, frequency shifting, hearing programs for various hearing situations, etc. Such data can also be useful in selecting a particular hearing device for the patient.

According to current solutions, such patient data would typically be provided either on paper, or stored in a centralised data storage system. Paper-based patient data transfer involves the dispenser manually entering the data into his or her local computer system, which is time-consuming and inefficient. Central data storage enables simple transfer of e.g. audiogram data, however presents several disadvantages of its own. Firstly, there are many different office management systems, with very little prospect of any one of them becoming an industry standard. As a result, there are data compatibility issues between systems, data formats, and so on. Central data storage, either in a local area network, wide area network, or in the so-called “cloud” requires all the use of the system to have access to a central data storage service, resulting in security issues and complex network topology to keep data secure. Every country has its own laws which define secure management of electronic patient records, and an IT solution based on centralised storage has to take into account all these various laws, which complicates data handling.

The present invention seeks to overcome at least one of the above-mentioned disadvantages.

### SUMMARY OF THE INVENTION

This object is achieved by a method of patient data exchange according to the independent claim. This method comprises providing patient data in a visual form, such as a conventional audiogram on paper, on the display of a tablet computer or smart phone, or displayed on a web application. This data may take the form of graphs, tables, matrices of figures, or standardised machine-readable forms such as one or more barcodes and/or smart codes, and may relate to audiogram data, patient personalia such as name, date of birth etc, and other useful data. This patient data is then digitally imaged, e.g. by use of a scanner or a digital camera, which latter may be integrated into e.g. a tablet computer or smart phone, so as to generate image data. This image data is then processed so as to automatically extract relevant patient data. This data processing is well-known and thus need not be described further. The extracted relevant patient data is then used for one of the following purposes, i.e. is exchanged with a utility, an app, or other computer program for performing at least one of:
selecting a specific hearing device from the various types of hearing device available, based on the relevant patient data. For instance, for a certain type of hearing loss, a behind-the-ear hearing device might be preferable to an in-ear hearing device, and since certain hearing programs may be useful for certain types of hearing loss, hence a hearing device equipped to carry out such hearing programs can be selected;
fitting a hearing device, i.e. adjusting the various parameters of the hearing device such as amplification, frequency-dependent amplification, frequency shift parameters and so on, to adjust the hearing device for the particular hearing loss of the patient;
adjusting a hearing program of a hearing device, i.e. adjusting the fitting of a hearing device for particular acoustic scenarios;
controlling a hearing device, such as by interfacing with the hearing device via a wire or wirelessly, so as to adjust hearing programs, parameters and so on. This can for instance be carried out via a smart phone or tablet computer app.

In consequence, the necessity for centralised data storage with attendant data security risks and so on is eliminated, since the relevant data can be exchanged extremely simply between the patient and the hearing device dispenser. Since the patient data is imaged e.g. by a camera or a scanner, there are no data compatibility issues which would be the case in the case of different data transfer formats and protocols. Furthermore, the dispenser does not need to enter the patient information manually.

In an embodiment, the patient data is an audiogram presented as a least one of: one or more graphs, one or more bar charts, one or more tables of data, one or more machine-readable codes, such as barcodes and/or smart codes.

In an embodiment, the patient data is provided on paper, displayed on a smartphone or tablet computer, or displayed on a web application. This present particularly convenient ways for the patient to keep and present his or her patient data.

In an embodiment, the imaging of the patient data is carried out by a digital camera, which may e.g. be integrated into a smart phone or tablet computer, or be a separate camera. This provides particularly convenient means to digitise the patient information.

In an embodiment, the image data is transferred to an office management system, in which is processed. Since the office management system can be stored locally in a desktop computer and/or server system, this enables the processing to be carried out in a fast and efficient manner due to the high level of processing power present.

In an embodiment, the image data is processed in a smart phone or tablet computer, which eliminates the requirement for office management system, enabling the method to be carried out with minimal equipment.

In an embodiment, processing the image data comprises formatting the information into a machine-readable standard such as a bar chart, data matrix, barcode, smart code or similar. This permits easy data transfer of the relevant patient data without requiring to fully re-extract the relevant patient data from the original patient data provided in visual form in the case in which this data was not provided already formatted in a machine-readable standard.

The invention further relates to a method of controlling a hearing device utilising any of the above-mentioned methods, comprising carrying out one of the above-mentioned methods, storing the extracted relevant patient data in a smartphone or tablet computer, and then controlling the hearing device by means of the smartphone or tablet computer based at least partly on at least part of the extracted relevant patient data. This enables e.g. an end user app on a smartphone or tablet computer to be easily provided with the relevant patient data, and then to control the functions of the hearing device in dependency thereof.

### BRIEF DESCRIPTION OF THE FIGURE

The invention will now be described in terms of nonlimiting embodiments as disclosed in the accompanying figure, which shows a flow diagram of the principle of the invention.

### DETAILED DESCRIPTION OF THE DRAWING

The sole figure shows a diagram of the principle of the invention. Patient data 10 are provided by the patient, e.g. in paper form, on the display of an electronic device such as a tablet computer, or displayed on a web application. This data is then digitised by scanning or digitally photographing the data 10 with digital camera 11, which may be integrated into a tablet computer, smart phone, desktop computer or similar, constituting a first electronic device 12. This data can either be processed directly in the first electronic device 12, or can be transferred via an interface 13 with an office management solution 14. Interface 13 may be of any convenient type such as Wi-Fi, ethernet, USB, Bluetooth, a local area network, or similar. The interface can likewise be merely re-photographing the data as displayed on the first electronic device 12. The first electronic device may reformat the data in a machine-readable standard such as one or more bar charts, data matrices, smart codes, or similar in the case of the data being transferred to the office management solution by rescanning or rephotographing. In the case in which the data is transferred to the office management solution 14, the office management solution 14 processes the data so as to extract the data necessary for dispensing a hearing device 15. Alternatively, the office management solution may be dispensed with, as illustrated schematically by dashed line 13a, and the first electronic device may process the data itself. This data is then used for at least one of:
Selecting the type and/or configuration of hearing device 15 suitable for the patient based on the patient data, for instance during a counseling or sales session and/or during a fitting session;
fitting the hearing device 15, that is to say adjusting the parameters of the hearing device to give comfortable hearing to the patient based on the patient data;
adjusting the hearing program of the hearing device 15;
programming the hearing device 15.

The patient data as originally provided may be provided in traditional graphic and/or tabular form, e.g. as an audiogram. Alternatively, the information can be provided already formatted using a machine-readable standard such as one or more bar charts, data matrices, smart codes, or similar.

As an alternative example, instead of the patient data being provided in visual form as above, the patient data can be provided in an audible form stored on a recording medium, such as on a tape, a CD, or as an audio file (e.g. in WAV, MP3, or other format) on an electronic device such as a thumb drive, smart phone, or tablet computer. This audible form can be spoken words, or encoded information in a format such as DTMF touch-tones, Morse code, or binary data. The patient data in audible form can then be played aloud and digitised by an audio input transducer such as a microphone, replacing digital camera 11 on the sole figure, thereby generating audio data. First electronic device 12 then processes the audio data to automatically extract the relevant patient data, which is then further processed and utilised as in the above embodiments.

The data can also be used for providing information to the patient via an end-user information app, for instance on the patient's smartphone or tablet computer 17. This end-user app can provide hearing device information, and may additionally be used for wirelessly controlling the hearing device 15 via wireless interface 16, e.g. for selecting hearing programs or adjusting hearing device parameters.

In consequence of the above-disclosed invention, the transfer of data required for selection, fitting, adjusting, programming, and controlling a hearing device is simplified, eliminating data compatibility issues and eliminating the requirement for a central data storage system.

Although the invention has been described with reference to specific embodiments, variations therefrom are possible without departing from the invention as defined by the scope of the claims.

What is claimed is:

1. Method of patient data exchange comprising the steps of:
providing patient data in visual form;
imaging said patient data digitally so as to generate image data;
processing said image data so as to automatically extract relevant patient data;
performing at least one of the following based at least partially on the extracted relevant patient data:
selecting a specific hearing device from a plurality of types of hearing device;
fitting a hearing device;
adjusting a hearing program of a hearing device;
controlling a hearing device.

2. Method according to claim 1, wherein the patient data is an audiogram presented as at least one of: one or more graphs, one or more bar charts, one or more tables of data, one or more machine-readable codes, such as barcodes and/or smart codes.

3. Method according to claim 1, wherein the patient data is provided on paper, displayed on a smartphone or tablet computer, or displayed on a web application.

4. Method according to claim 1, wherein the imaging of the patient data is carried out by a digital camera, optionally a digital camera of a smartphone or tablet computer.

5. Method according to claim 1, wherein the image data is transferred to an office management system, in which it is processed.

6. Method according to claim 1, wherein the image data is processed in a smartphone or tablet computer.

7. Method according to claim 1, wherein processing the image data comprises formatting the information into a machine-readable standard such as a bar chart, data matrix, barcode, smart code etc.

8. Method of controlling a hearing device comprising the steps of:
carrying out the method for patient data exchange according to claim 1;
storing the extracted relevant patient data in a smartphone or tablet computer;
controlling the hearing device by means of the smartphone or tablet computer based at least partly on at least part of the extracted relevant patient data.
